(19) United States
(12) Patent Application Publication
(10) Pub. No.: US 2005/0021564 A1
(43) Pub. Date: Jan. 27, 2005

(54) System for storing data and method for recording data

(76) Inventors: Andrzej Szajdecki, Zielona Gora (PL); Adam Biniszkiewicz, Zielona Gora (PL)

Correspondence Address: HOFFMANN & BARON, LLP, 6900 JERICHO TURNPIKE, SYOSSET, NY, 11791, US

(21) Appl. No.: 10/501,245

(22) PCT Filed: Jan. 16, 2003
(86) PCT No.: PCT/PL03/00005

(30) Foreign Application Priority Data
Jan. 21, 2002 (PL) P-351784

(51) Int. Cl. G06F 17/30

(52) U.S. Cl. 707/200

(57) ABSTRACT

A system for storing data forming a single file (61) recorded as an undivided file or recorded in fragments (61) on a data area has a separate file (E) containing information related to the single file (61). Location of the separate file (E) recorded on the data area is not predefined. The separate file is a set of tables consisting of at least one table of records containing at least one record and/or a record (75) of records table (E) of table extension (EO) and/or records (96) table containing at least one record of single file fragments and records of records table of table extension and/or a set of records of single file fragments, and the number of tables of further table extensions is not limited.

The invention relates to a system for storing data and a method for recording data.

Besides common file systems such as FAT (File Allocation Table), NTFS (New Technology File System), BFS (BeOS File System) and UFS (UNIX File System), and their variants, a file sharing system, running on different computers connected with each other in a network, where each computer has its individual operating system, and can access files stored on disks connected to the network, is known from the U.S. Pat. No. 5,960,446.

In the U.S. Pat. No. 6,308,183 a file management system capable of managing vacant blocks so that it is possible to optimize unoccupied areas in mass memory, is registered.

Information stored on disks with all such file systems, because of the universality of these systems, can be read by any personal computer with a proper system, and, additionally, is designed for managing medium-sized files are used.

The object of the present invention, is that in a system for storing information of a single file recorded as an undivided file or recorded in fragments, information about the single file is recorded in a separate file, whose location of recording is not predefined.

Preferably the separate file is a set of tables consisting of at least one table of records containing at least one record and/or a record of records table of table extension and/or records table containing at least one record of single file fragments and records of records table of table extension and/or a set of records of single file fragments, wherein the number of tables of further table extensions is not limited.

Preferably, the separate file, called an allocation chain, consists of at least one table of records and its/theirs tables of extension, and information about extension table of records table or its/theirs further tables of extension is stored in the record of table or the record of table extensions, whose extensions are its further extensions.

Preferably, the allocation chain created from tables of records of its own extensions and/or records of table extensions and records of fragments of the single file and/or records of fragments of the single file, is organized into a branched tree, called a binary tree, which at ends of branches carries information about the termination of branches, and at its own end has information of its own termination.

Preferably, information characterizing a single file or its part is recorded in many separate files.

Preferably, information characterizing the single file stored in fragments, is recorded in a separate file consisting of at least one record that may be stored in any place.

Preferably, a record forming a part of the separate file consists of records with information describing fragments of the single data file and/or at least one record containing information of at least its one own extension.

Preferably, a record and/or a record extension, forming a part of the separate file, consists of records with information characterizing fragments of the single data file and/or at least one record with information about its further extensions.

Preferably, the separate file with information describing the single data file and consisting of at least one record contains at least information about a number of logically separated smallest areas reserved in one continuous block of logically separated smallest areas and about the address of the first logically separated smallest area at a continuous block of logically separated smallest areas, wherein this information is binary compressed and contains values with a sign, where a negative value representing the amount of logically separated smallest areas means that a record has its own extension with a numerically expressed quantity of logically separated smallest areas. At the end of the separate file information is given about its end and/or about the number of free bytes and the time of modification.

Preferably, information consisting of records and describing fragments of the data file is grouped, and information about it is stored in a separate file consisting of at least one record.

Preferably, information describing a single data file, which is stored in fragments, is stored in a separate file comprising at least one record.

It is also the object of the invention, that in a method of storing data of a single file, recorded as an undivided file or recorded in fragments, information about the single file is stored in a separate file, whose place of recording is not predefined.

Preferably, the separate file comprises at least one table of records containing at least one record and/or a record of records table of table extension and/or a table of records containing at least one record of single file fragments and records of records tables of tables extensions and/or a set of records of single file fragments, wherein there the number of tables of further extensions is not limited.

Preferably, the separate file is arranged as an allocation chain created by tables of records of its own extensions and/or records of tables extensions and records of single file fragments and/or records of single file fragments, formed as a branched tree, called a binary tree where information about the termination of a branch is placed at an end of a branch and information about its termination is placed at an end of a tree.

The object of this invention is shown in implementation examples in the enclosed drawings, where

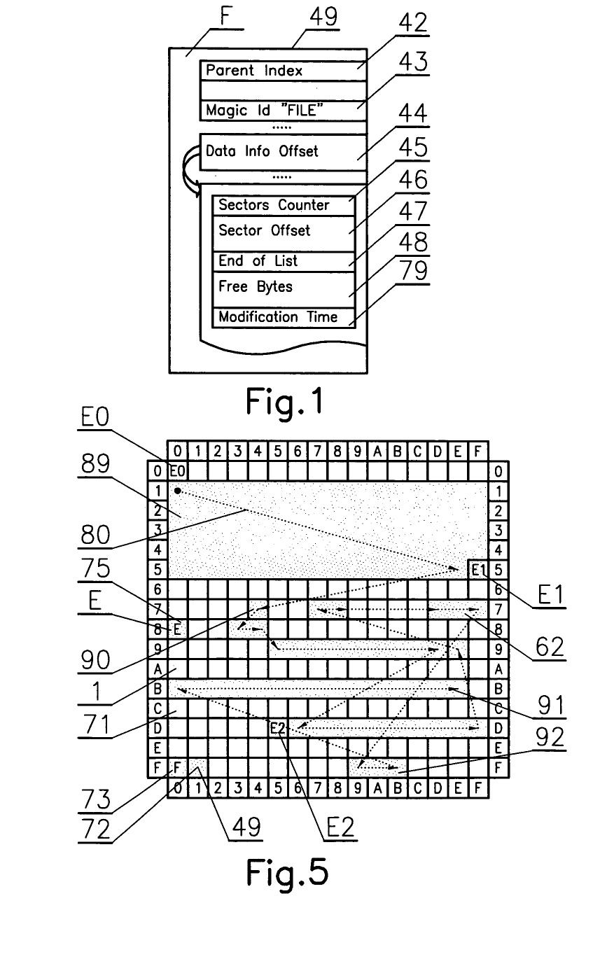

FIG. 1 shows a table of records of a single set that is a file without extensions,

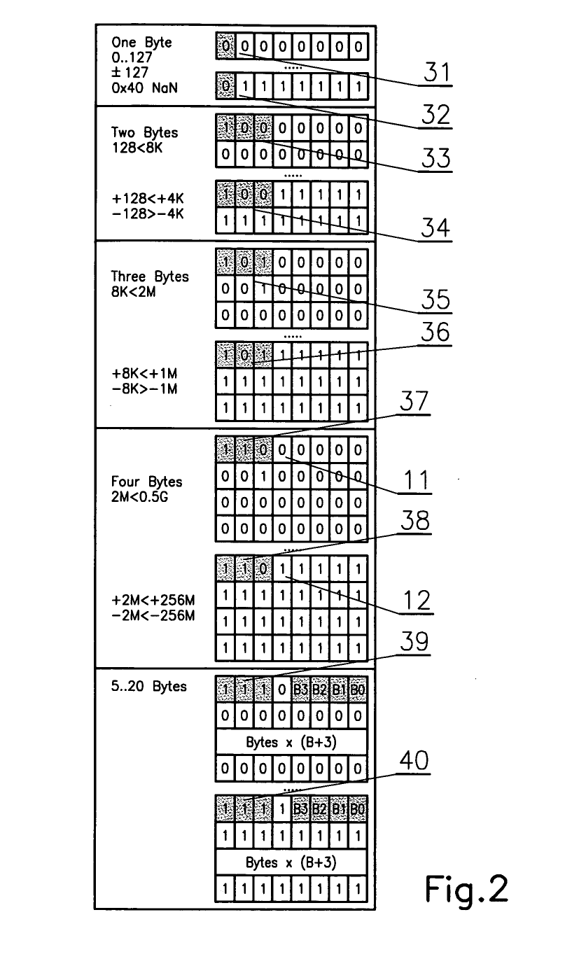

FIG. 2 shows binary packing,

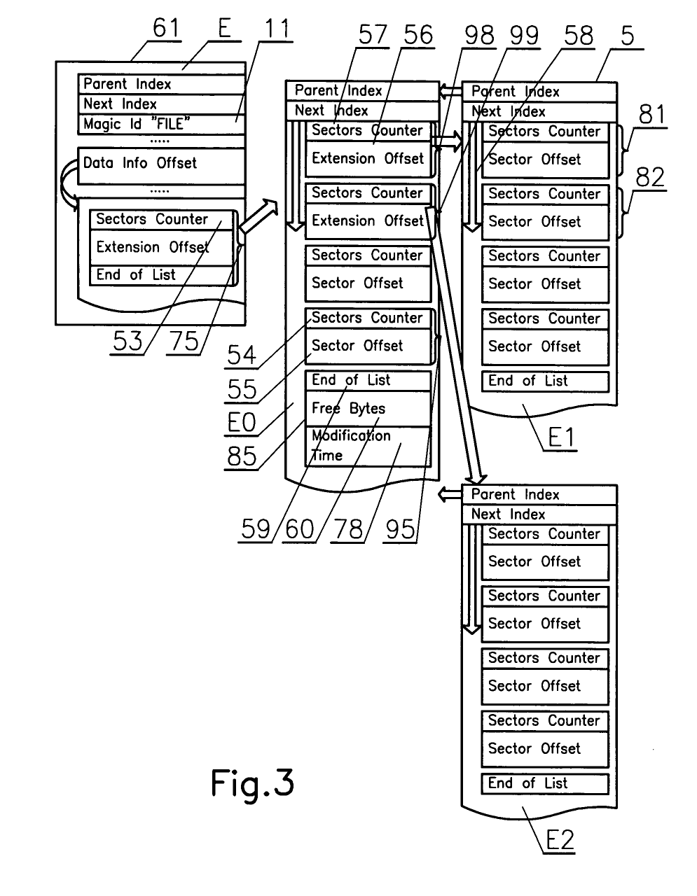

FIG. 3 shows a rule of allocation chain creation,

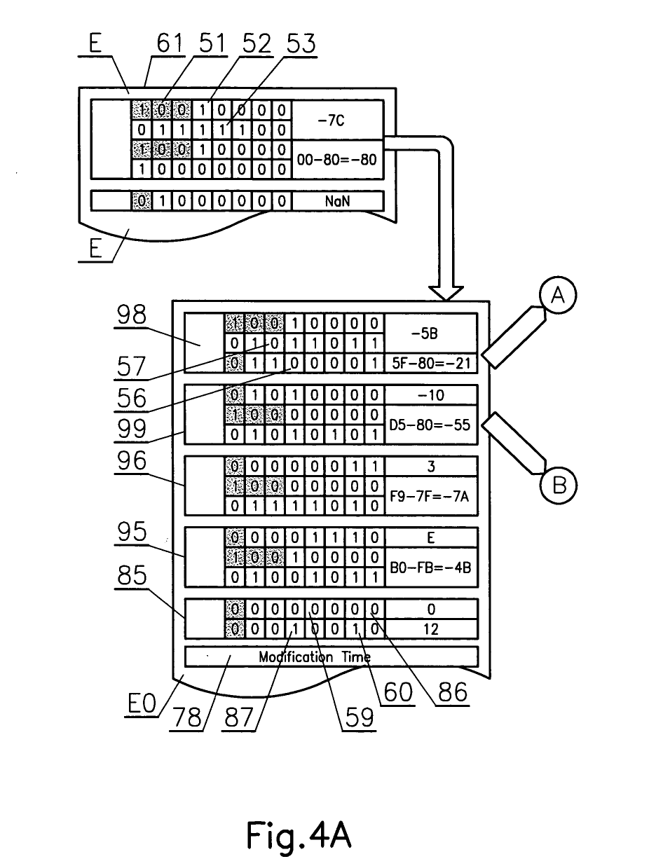

FIGS. 4A and 4B show an example of an allocation chain, which, regarding the lack of space on one sheet, has been divided into parts A and B; and

FIG. 5 shows a fragment of a memory of a device for data storage with a recorded file.

The invention will be described in detail with reference to the system of data storage on a hard disk. However, the presented solution can be applied to other devices for data storage as well.

Data recorded in a data storage device, for example on a hard disk, have their definite place and information regarding areas occupied by data sets of data are recorded in records table of variable size, which, for the purpose of the invention description, has been termed a chain of allocations. Each record that constitutes a separate data set defines a single allocation unit, which can be a fragment of a file or a file, and which is represented by at least two parameters, namely a sector counter and a start sector for a given allocation represented by a Logical Block Address.

FIG. 1 shows the table F of records describing a data set or a set of information 49 called a file, recorded in one sector which is a logically separated smallest area 1 of the hard disk. The table F, in this case identical with the record F, gives the directory index 42 in which the file 49 is listed, along with the unique tag Magic Id File 43 used for verification whether the sector being read contains information about the file, the data information offset 44 concerning the place within the sector from which the information about the allocation chain begins from, the number 45 of sectors occupied by the file 49, so-called sectors counter, a sector offset being a logical address 46 of a start sector, information 47 about the end of the list, the number 48 of free bytes and, most often given at the end of the record, the time of modification 79.

In order to reduce the occupied space, the data concerning the allocation unit are binary packed. This method of compression is effective for small numerical values; therefore the start sector is coded as a difference between the last allocated address and the currently described one. The method of coding is presented in FIG. 2, where for the presented solution the numerical values are numbers with a sign. The size of the numerical values is signaled by the tag 31, 32, 33, 34, 35, 36, 37, 38, 39, 40 specified by the most significant bits.

If the most significant bit, namely the tag 31, 32 is equal to “0”, it means that on the following seven bits a value from the range 0 . . . 127 or ±63, depending on the bit specifying the sign, is recorded. This number is packed into one byte.

If the three most significant bits i.e. the tag 33, 34 have the value of “100”, it means that the value recorded on the following thirteen bits is a value from the range 128 . . . 8K or a number from the range 64 . . . 4K or −4K . . . −63, depending on the bit qualifying the sign. This number is packed in two bytes.

If the three most significant bits, i.e. the tag 35, 36 have the value of “101”, it means that the value recorded on the following twenty-one bits is a value from the range 8K to 2M or a number in the range 8K . . . 1M or −1M . . . −8K, depending on the bit determining the sign. This number is packed in three bytes.

If the three most significant bits i.e. the tag 37, 38 take the value of “110”, it means that the value recorded on the following twenty nine bits is a value from the range 2M . . . 0.5G or a number from the range 2M . . . 256M or −256M . . . −2M, depending on the bit determining the sign. This number is packed in four bytes.

In the case where a disk is larger than 128 GB and the sector address has to be addressed by a number of a size larger than 28 bits 39, 40, the three most significant bits, i.e. the tag, are fixed to “111”, and the bit describing the sign is followed by four bits, which determine the number of bytes.

The first numerical values 31, 33, 35, 37, 39 describe the number of sectors occupied by a file or a file-fragment, and the second numerical values 32, 34, 36, 38, 40 describe the offset to the recently allocated fragment of a file which is a separate unit of allocation. The digit 11, 12, placed after the tag 37, 38 determines a positive or negative numerical value. In the presented solution, digit “0” means a positive value and digit “1” means a negative value while compressing.

FIGS. 3, 4A and 4B show tables E, E0, E1 and E2 of records creating an allocation-chain of file 61, which is divided into ten fragments. FIG. 3 illustrates the rule of allocation-chain creation. In FIGS. 4A and 4B each record of a file fragment gives at least the number of sectors occupied by a given fragment, and the numerical value describing the distance from the earlier-allocated fragment of the file. If the file is so strongly fragmented, the number of records is large, and searching for a proper sector, for example whilst moving within the file, could be very time-consuming. To obviate this problem, the field 53 of the record describing the sectors counter, denotes a number with a sign. The sign of the sector-number is specified by a digit “0” or “1” which is the first digit 52 following the tag 51. Digit “0” means a positive value, and digit “1” means a negative value. If the value 54 of the number of sectors is positive, then the field 55 of the start sector describes the distance from the earlier-recorded fragment of a file, giving a binary packed number according to the rule presented in FIG. 4. For example, the eighth fragment 62 of the file 61 contains a positive number 54 of sectors, marked by “0” after the tag of the sectors counter, equal to 0x03 in the hexadecimal system, and “11” in the binary system, and the start address, equal to 0x7D, can be calculated as a sum of the address 0x78 of the last sector of the previous file-fragment and a value 0x05 of the start address/distance. For a negative value, indicated by digit “1” after the sector-counter tag, the field 56 points to the address of a record extension of the file 61, and the field of sector counter 57 determines the number of sectors allocated by the extension of the file 61. The extensions of records and files are organized into binary trees to optimize the address-reading time of particular allocations while searching within a file. The zero value 59 of the field of the sectors counter is reserved to mark the end of the allocation chain and then the field 60, referring to the sector offset, provides information about the number of free bytes in allocated sectors and is used to calculate the file size. The first four fragments of the file 61 extension, beginning at the first fragment 63, occupy subsequently 0x4F, 0×01, 0x02, 0x09 sectors which in total equals to 0x5B sectors and this number is set in the field 57 of extension table E0 of records table E. The whole file 61 is written in 0x7C sectors, which is indicated by the field 53 of the first base-record of record-table E of the file 61. The number of bytes occupied by the file 61 is a difference between the number of bytes of sectors given in the base record in the field 53 and the number of free bytes given at the end of the file in the field 60. Assuming, that one sector occupies 512 bytes of memory and 0x12 bytes are free in the occupied sectors, it means that with 0x5C occupied sectors, a 63470 bytes-long file is a result.

FIG. 5 shows the memory section 71 of a device for information or data storage, which, in the reviewed example, is a hard disk having a sector as the logically separated smallest area 1 element. The data from record tables E, E0, E1, E2 of the file 61 and its ten fragments, and the record F of the non-fragmented file 49 is written in section 71. The single square of the memory section 71 represents a single sector of the hard disk. The positions of record tables F, E, E0, E1, E2 together with the files 49 and 61, as an example only, are random, but they correspond with the information about the file 49, 61 shown on FIGS. 4A and 4B.

The file 49 in the example adduced occupies only one sector 72 and its record F is placed in the address 0×F0.

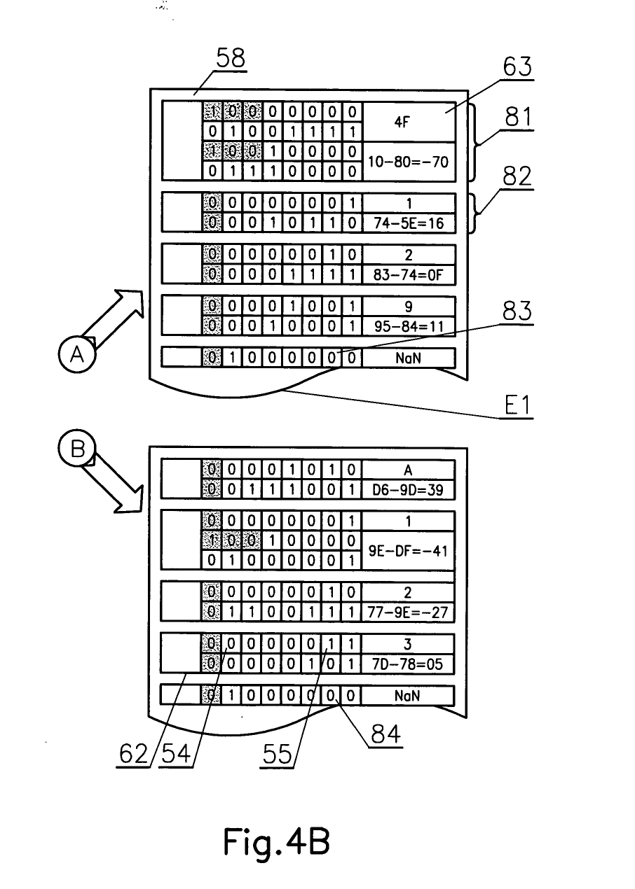

The first table E of records, containing the so-called base record of the file 61, is placed at address 0x80, the record-table E0 of the extension of records table E of the file 61, is placed at address 0×00, the table E1 of the first extension of records table E0 is placed at address 0x5F, and the records table E2 of the second extension of table E0 is placed at address 0×D5. The first record 81 of the file 61 starts from sector 0x10 and is marked with an arrow 80 which is followed by further arrows depicting the whole file. From the information presented in FIGS. 6A, 6B and the supplementary information in FIG. 7, it emerges that the value 52 in the field 53 of the sectors counter is negative which means that the value in the field of the start-address/offset describes the length of the file extension. Taking into account that the first record 75 is placed at address 0x80 and taking into account the field of the start-address containing the value −0x80, one can calculate the position of records-table E0 as an extension of the records table E, performing the calculation: 0x80−0x80=0x0. The first record 98 and the second record 99 of the table E0 written at the same address also have a negative value in the field of the sector-counter, which means that the field of the start-address distance describes the distance of the next extension table E1 of the table E0 in relation to the base record of the table E0. That address can be calculated according to the formula 0x80−0x21=0x5F, and it describes the position of the first table E1 of the extension. The first record 81 and the second record 82 of the first table E1 of extension E0 have a positive sign in the field of the sector-counter, which means that it provides the number of continuous sectors allocated from the address given on the basis of the field of start-address/offset of the table E of records. That address, calculated on the basis of the value of the field representing the start-address/offset, equals 0x80−0x70=0x10. The first record 81 of the table E1 indicates that the first file-fragment 89 is written on 0x4F sectors starting from the address 0x10. The next record 82 in this extension specifies that the second fragment 90 of the file is stored on one sector beginning from the address 0x74 which has been calculated as the sum of address 0x5E of the last sector of the first fragment 89 and the value 0x16 given in the field of the start-address/offset of the second fragment 90. Each record describes the allocated areas on the hard disk in the way described above. The appearance of the sequence NaN 83, 84, binary 01000000, in the extension of the record denotes the end of the list of records. At the end of the allocation-chain the terminal record 85 appears with the sector counter 86 equal to 0, and the field 87 of the sector offset describes the amount of free bytes in the sector where the most recent data was allocated. This makes it possible to calculate the total space occupied by the data recorded on the disk.

After the last record 85 the time 78 of the last modification of the file is given, which enables instant information about the history of the processing of the file.

1-18.(canceled).

19. A system for storing data forming a single file (49, 61) recorded as an undivided file (49) or recorded in fragments (61) on a data area and for controlling access to the data stored on the data area comprising
a separate file (F, E) containing information related to the single file (49, 61) wherein the location of the separate file (F, E) recorded on the data area is not predefined.

20. The system for storing data, according to claim 19, wherein the separate file is a set of tables consisting of at least one table (F, E) of records containing at least one record (F) and/or a record (75) of records table (E0) of extension of table (E) and/or records table (E0) containing at least one record (95, 96) of single file (61) fragments and records (98, 99) of tables (E1, E2) of records of extension of table (E0) and/or a set of records (81, 82) of single file (61) fragments, and the number of tables of further table extensions is not limited.

21. The system for storing data, according to claim 19, wherein the separate file is an allocation chain, which consists of at least one table of records and its/theirs tables of extension, and information about extension table (E0) of records table (E) or its/theirs further tables (E1, E2) of extension is stored in the record of table (E) or the record of table (E0) extensions, whose extensions are its further extensions (E1, E2).

22. The system for storing data, according to claim 21, wherein the allocation chain created from tables (E) of records of its own extensions (E0) and/or records (98, 99) of table extensions (E1, E2) and records (95, 96) of fragments of the single file (61) and/or records (81, 82) of fragments of the single file (61), is organized into a branched tree, called a binary tree, which at ends of branches carries information about the termination of branches, and at its own end has information of its own termination.

23. The system for storing data, according to claim 19, wherein information characterizing the single file (61) or its part is recorded in many separate files.

24. The system for storing data, according to claim 19, wherein information characterizing a single file stored in fragments is recorded in a separate file consisting of at least one record stored in any place.

25. The system for storing data, according to claim 19, wherein a record forming a part of the separate file consists of records with information describing fragments of a single file and/or at least one record containing information of at least its one own extension.

26. The system for storing data, according to claim 19, wherein a record and/or a record extension, forming a part of the separate file, consists of records with information characterizing fragments of the single file and/or at least one record with information about its further extensions.

27. The system for storing data, according to claim 19, wherein the separate file with information describing the single file and consisting of at least one record contains at least information about a number of logically separated smallest areas (1) reserved in one continuous block of logically separated smallest areas (1) and about the address of the first logically separated smallest area (1) at a continuous block of logically separated smallest areas (1) wherein the information is binary compressed and contains values with a sign, and wherein a negative value representing the amount of logically separated smallest areas (1) means that a record has its own extension with a numerically expressed quantity of logically separated smallest areas (1), and wherein the information about its termination and/or about the number of free bytes and the time of modification is given at the end of the separate file.

28. The system for storing data, according to claim 19, wherein information consisting of records and describing fragments of the single file is grouped, and information about it is stored in the separate file consisting of at least one record.

29. A method for recording data of a single file, recorded as an undivided file or recorded in fragments on a data area and for controlling access to the data stored on the data area comprising the following step:
storing a separate file containing information related to the single file (F, E) on the data area in a location (73, 75) not predefined.

30. The method for recording data, according to claim 29, wherein the separate file comprises at least one table (E, F) of records containing at least one record (F) and/or a record (75) of records table (E0) of extension of table (E) and/or a table (E0) of records containing at least one record (95, 96) of single file (61) fragments and records (98, 99) of records tables (E1, E2) of extensions of table (E0) and/or a set of records (81, 82 of single file (61) fragments wherein there is no limit to the potential number of tables of further extensions.

31. The method for recording data, according to claim 29, wherein the separate file is an allocation chain created by tables (E) of records of its own extensions (E0) and/or records (98, 99) of tables extensions (E1, E2) and records (95, 96) of single file (61) fragments and/or records (81, 82) of single file (61) fragments, formed as a branched tree, called a binary tree wherein information about the termination of a branch is placed at an end of a branch and wherein information about the termination of the allocation chain is placed at an end of the branched tree.

32. The method for recording data, according to claim 29, wherein information characterizing the single file (61) or its part is recorded in many separate files.

33. The method for recording data, according to claim 29, wherein information characterizing a single file stored in fragments is recorded in a separate file consisting of at least one record stored in any place.

34. The system for storing data, according to claim 29, wherein a record forming a part of the separate file consists of records with information describing fragments of a single file and/or at least one record containing information of at least its one own extension.

35. The method for recording data, according to claim 29, wherein a record and/or a record extension, forming a part of the separate file, consists of records with information characterizing fragments of the single file and/or at least one record with information about its further extensions.

36. The method for recording data, according to claim 29, wherein the separate file with information describing the single file and consisting of at least one record contains at least information about a number of logically separated smallest areas reserved in one continuous block of logically separated smallest areas and about the address of the first logically separated smallest area at a continuous block of logically separated smallest areas wherein the information is binary compressed and contains values with a sign, and wherein a negative value representing the amount of logically separated smallest areas means that a record has its own extension with a numerically expressed quantity of logically separated smallest areas, and wherein the information about its termination and/or about the number of free bytes and the time of modification is given at the end of the separate data set.

37. A system for storing data comprising:
a data area;
files containing stored data and stored as undivided files or stored in fragments on the data area; and
a table set stored on the data area in a not predefined location and containing information related to the files and consisting of at least one table of records containing at least one record and/or a record of records table of extension of table and/or records table containing at least one record of single file fragments and records of tables of records of extension of table and/or a set of records of single file fragments wherein a number of tables of further table extensions is not limited and wherein the table set contains at least information about a number of logically separated smallest areas forming one continuous block of logically separated smallest areas and about an address of a first logically separated smallest area of the continuous block of logically separated smallest areas, and wherein the information is binary compressed and contains values with a sign, and wherein a negative value representing the number of logically separated smallest areas means that a record has its own extension with a numerically expressed quantity of logically separated smallest areas.

38. A method for recording data comprising the following steps:
storing data as an undivided file or in fragments on a data area;
forming a table set containing information related to the data stored as the undivided file or in the fragments and consisting of at least one record table containing at least one record and storing the table set on the data area in a not predefined location; and
forming table extensions containing information related to the data stored as the undivided file or in the fragments and consisting of at least one record table containing at least one record and storing the table extensions on the data area wherein a number of tables of further table extensions is not limited and wherein the table set contains at least information about a number of logically separated smallest areas forming one continuous block of logically separated smallest areas and about an address of a first logically separated smallest area of the continuous block of logically separated smallest areas, and wherein the information is binary compressed and contains values with a sign, and wherein a negative value representing the number of logically separated smallest areas means that a record has its own extension with a numerically expressed quantity of logically separated smallest areas.
